(19) United States
(12) Patent Application Publication
(10) Pub. No.: US 2007/0083021 A1
(43) Pub. Date: Apr. 12, 2007

(54) Fluorocopolymer, method for its production and resist composition containing it

(75) Inventors: Masataka Eda, Tokyo (JP); Yoko Takebe, Tokyo (JP); Osamu Yokokoji, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY, LIMITED, Tokyo (JP)

(21) Appl. No.: 11/593,549

(22) Filed: Nov. 7, 2006

Related U.S. Application Data
(63) Continuation of application No. PCT/JP05/08361, filed on May 6, 2005.

(30) Foreign Application Priority Data
May 7, 2004 (JP) 2004-138230

(51) Int. Cl. C08F 236/16

(52) U.S. Cl. 526/252

(57) ABSTRACT

A fluorocopolymer having units derived from a monomer unit formed by cyclopolymerization of a fluorinated diene and units derived from a monomer unit formed by cyclopolymerization of a functional group-containing fluorinated diene having a specific structure or a monomer unit formed by polymerization of an acrylic monomer having a specific structure, a method for its production, and a resist composition.

### BACKGROUND OF THE INVENTION

1. Field of the Invention

The present invention relates to a novel fluorocopolymer, a method for its production and a resist composition.

2. Discussion of Background

As fluoropolymers having functional groups, functional group-containing fluoropolymers are known which are used for fluorinated ion exchange membranes, curable fluorinated resin coating materials, etc. They are all basically straight chained polymers, and they are obtainable by copolymerization of a fluoroolefin represented by tetrafluoroethylene with a monomer having a functional group.

Further, a polymer containing functional groups and having a fluorinated alicyclic structure in its main chain, is also known. JP-A-4-189880, JP-A-4-226177, JP-A-6-220232 and WO02/064648 disclose, as a method for introducing functional groups to a polymer having a fluorinated alicyclic structure in its main chain, e.g. a method of utilizing terminal groups of a polymer obtained by polymerization, a method of subjecting a polymer to high temperature treatment to oxidize and decompose side chains or terminals of the polymer to form functional groups, or a method of copolymerizing a monomer having a functional group, and if necessary, adding treatment such as hydrolysis to introduce functional groups.

The above-mentioned methods are available as methods for introducing functional groups to a polymer having a fluorinated alicyclic structure in its main chain. However, the method for introducing functional groups by treating the terminal groups of the polymer, has a drawback that the functional group concentration is low, and no adequate characteristics of the functional groups can be obtained. Whereas, by the method for introducing functional groups to a polymer by copolymerizing a monomer having a functional group, there will be a problem such that if the copolymerization ratio of the monomer is increased so as to increase the functional group concentration, the glass transition temperature (Tg) tends to decrease, whereby the mechanical properties of the polymer tend to decrease.

### SUMMARY OF THE INVENTION

It is an object of the present invention to provide a fluorocopolymer having high concentration of functional groups and adequate characteristics of the functional groups and having high transparency in a wide wavelength region, and a method for its production. Further, it is to provide a resist composition obtainable from the fluorocopolymer, which can form a chemical amplification type resist excellent particularly in transparency for far ultraviolet rays such as KrF or ArF excimer laser or vacuum ultraviolet rays such as F₂ excimer laser and dry etching characteristics, and a resist pattern excellent in sensitivity, resolution, dissolution velocity, flatness, heat resistance and the like.

In order to achieve the above objects, the present invention provides the following.

1. A fluorocopolymer (A) having units derived from a monomer unit formed by cyclopolymerization of a fluorinated diene represented by the following formula (1) and units derived from a monomer unit formed by cyclopolymerization of a functional group-containing fluorinated diene represented by the following formula (2) (provided that the fluorinated diene represented by the formula (1) is excluded):
CF₂═CFCH₂CH(C(CF₃)₂(OR³) )CH₂CR¹═CHR² (1)
wherein each of R¹ and R² which are independent of each other, is a hydrogen atom or an alkyl group having at most 12 carbon atoms, and R³ is a hydrogen atom, an alkyl group having at most 20 carbon atoms, an alkoxycarbonyl group having at most 15 carbon atoms or CH₂R⁴ (wherein R⁴ is an alkoxycarbonyl group having at most 15 carbon atoms), provided that the alkyl group, the alkoxycarbonyl group or R⁴ constituting R³ may have some or all of its hydrogen atoms substituted by fluorine atoms and may have an etheric oxygen atom:
CF₂═CR⁶—Q—CR⁷═CH₂ (2)
wherein each of R⁶ and R⁷ which are independent of each other, is a hydrogen atom, a fluorine atom, an alkyl group having at most 3 carbon atoms, a fluoroalkyl group having at most 3 carbon atoms, or a cyclic aliphatic hydrocarbon group, and Q is an alkylene group, an oxyalkylene group, a fluoroalkylene group or a fluorooxyalkylene group, having a functional group or a functional group-containing side chain group.

2. A fluorocopolymer (B) having units derived from a monomer unit formed by cyclopolymerization of the fluorinated diene represented by the above formula (1) and units derived from a monomer unit formed by polymerization of an acrylic monomer represented by the following formula (3):
CH₂═CR⁸C(O)OR⁹(3)
wherein R⁸ is a hydrogen atom, a fluorine atom, an alkyl group having at most 3 carbon atoms, or a fluoroalkyl group having at most 3 carbon atoms, and R⁹ is an alkyl group having at most 20 carbon atoms, provided that the alkyl group constituting R⁹ may have some or all of its hydrogen atoms substituted by fluorine atoms or hydroxyl groups and may have an etheric oxygen atom or an ester bond.

3. A method for producing the above fluorocopolymer (A) or the above fluorocopolymer (B), which comprises radical copolymerization of the fluorinated diene represented by the above formula (1), and the functional group-containing fluorinated diene represented by the above formula (2) or the acrylic monomer represented by the above formula (3).

Here, in the method for producing the fluorocopolymer of the present invention, as the functional group-containing fluorinate diene represented by the above formula (2), the fluorinated diene represented by the above formula (1) is excluded.

4. A resist composition comprising the above fluorocopolymer (A) or the above fluorocopolymer (B), an acid-generating compound which generates an acid under irradiation with light, and an organic solvent.

According to the present invention, it is possible to produce a fluorocopolymer having an alicyclic structure in its main chain and having functional groups in its side chains. The fluorocopolymer of the present invention has high chemical stability and heat resistance. Yet, functional groups are introduced in the side chains of its ring, whereby it is possible to exhibit sufficient characteristics of functional groups without bringing about a decrease of Tg, which used to be difficult to accomplish with conventional fluoropolymers. Further, such a fluorocopolymer has high transparency in a wide wavelength region. The resist composition of the present invention can be used as a chemical amplification type resist excellent particularly in transparency for far ultraviolet rays such as KrF or ArF excimer laser or vacuum ultraviolet rays such as F₂ excimer laser and dry etching characteristics, and can readily form a resist pattern excellent in sensitivity, resolution, flatness, heat resistance and the like.

### DETAILED DESCRIPTION OF THE PREFERRED EMBODIMENTS

By the present invention, it is possible to obtain a fluorocopolymer (A) having units derived from a monomer unit formed by cyclopolymerization of a fluorinated diene represented by the following formula (1) (hereinafter referred to as fluorinated diene (1)) and units derived from a monomer unit formed by cyclopolymerization of a functional group-containing fluorodiene represented by the following formula (2) (provided that the fluorinated diene represented by the formula (1) is excluded, and -hereinafter referred to as fluorinated diene (2)).

In this specification, the “units derived from a monomer unit” mean monomer units themselves or units having functional groups in the monomer units chemically converted by e.g. functional group conversion after the polymerization.
CF₂═CFCH₂CH(C(CF₃)₂(OR³))CH₂CR¹═CHR² (1)

In the formula (1), each of R¹ and R² which are independent of each other, is a hydrogen atom or an alkyl group having at most 12 carbon atoms. The alkyl group having at most 12 carbon atoms may be not only a linear or branched aliphatic hydrocarbon group but also a cyclic hydrocarbon group or a hydrocarbon group having a cyclic hydrocarbon group. In this specification, the cyclic hydrocarbon group means that the cyclic hydrocarbon group is directly bonded to the rest of the compound of the formula (1). Whereas the hydrocarbon group having a cyclic hydrocarbon group means that the cyclic hydrocarbon group is bonded to the rest of the compound of the formula (1) via another hydrocarbon group such as an alkyl group.

The cyclic hydrocarbon group is preferably a hydrocarbon group having at least one cyclic structure, and includes the following monocyclic saturated hydrocarbon groups such as a cyclobutyl group, a cycloheptyl group and a cyclohexyl group, heterocyclic saturated hydrocarbon groups such as a 4-cyclohexylcyclohexyl group, polycyclic saturated hydrocarbon groups such as a l-decahydronaphthyl group and a 2-decahydronaphthyl group, crosslinked cyclic saturated hydrocarbon groups such as a 1-norbornyl group and a 1-adamantyl group, and spirohydrocarbon groups such as a spiro[3.4]octyl group:

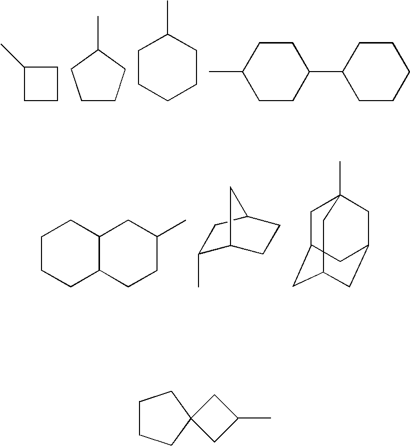

Each of the above R¹ and R² is preferably a hydrogen atom, a methyl group or a cyclic aliphatic hydrocarbon group having at most 6 carbon atoms, particularly preferably a hydrogen atom or a methyl group. Most preferably, R¹ and R² are simultaneously hydrogen atoms.

R³ is a hydrogen atom, an alkyl group having at most 20 carbon atoms, an alkoxycarbonyl group having at most 15 carbon atoms or CH₂R⁴ (wherein R⁴ is an alkoxycarbonyl group having at most 15 carbon atoms). The alkyl group, the alkoxycarbonyl group or R⁴ constituting R³ may have some or all of its hydrogen atoms substituted by fluorine atoms and may have an etheric oxygen atom.

The alkyl group having at most 20 carbon atoms, which may have some or all of its hydrogen atoms substituted by fluorine atoms and may have an etheric oxygen atom may be not only a linear or branched aliphatic hydrocarbon group but also a cyclic hydrocarbon group or a hydrocarbon group having a cyclic hydrocarbon group. The cyclic hydrocarbon group may be the same group as described above and may have an etheric oxygen atom in the cyclic structure. Specific examples thereof include a methyl group, a trifluoromethyl group, t-C₄H₉, CH₂OCH₃, CH₂OC₂H₅, CH₂OCH₂CF₃, CH₂OC₂H₄OCH₃, a 2-tetrahydropyranyl group and groups represented by the following [1] (represented by the form of —OR³ in order to define the bonding position):

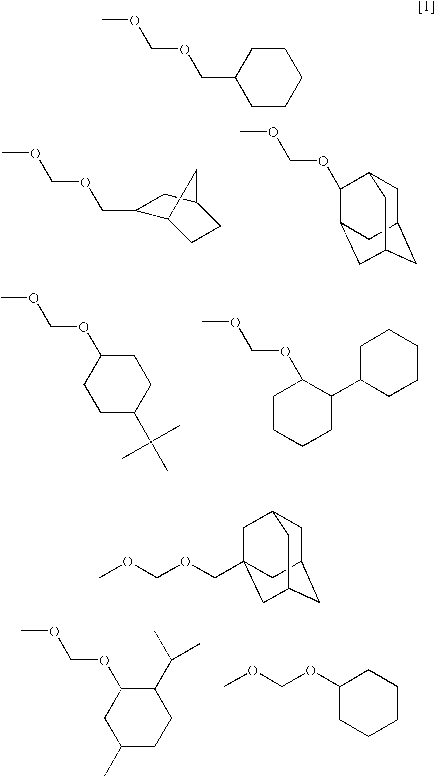

The alkoxycarbonyl group having at most 15 carbon atoms and CH₂R⁴ are represented by COOR¹⁰ and CH₂COOR¹⁰, respectively, and R¹⁰ is an alkyl group having at most 14 carbon atoms. Specifically, COO(t-C₄H₉), CH₂COO(t-C₄H₉), COO(2-AdM) and CH₂COO(2-AdM) may, for example, be mentioned. Here, 2-AdM represents a 2-methyladamant-2-yl group.

R³ is preferably at least one member selected from the group consisting of a hydrogen atom, a methyl group, a trifluoromethyl group, t-C₄H₉, CH₂OCH₃, CH₂OC₂H₅, CH₂OCH₂CF₃, CH₂OC₂H₄OCH₃, a 2-tetrahydropyranyl group, COO(t-C₄H₉), CH₂COO(t-C₄H₉), COO(2-AdM), CH₂COO(2-AdM) and groups represented by the above [1] (represented by the form of —OR³ in order to define the bonding position).
CF₂═CR⁶—Q—CR⁷═CH₂ (2)

In the formula (2), each of R⁶ and R⁷ which are independent of each other, is a hydrogen atom, a fluorine atom, an alkyl group having at most 3 carbon atoms, a fluoroalkyl group having at most 3 carbon atoms, or a cyclic aliphatic hydrocarbon group, and Q is an alkylene group, an oxyalkylene group, a fluoroalkylene group or a fluorooxyalkylene group, having a functional group or a functional group-containing side chain group. Particularly preferably R⁶ is a fluorine atom and R⁷ is a hydrogen atom.

Q is a group having a functional group or a functional group-containing side chain. In the present invention, the functional group is meant for a group which provides a desired function, and it may, for example, be an ion exchange group, an adhesive group, a crosslinkable group or a developable group. Such a functional group may, for example, be OR¹¹ (wherein R¹¹ is a hydrogen atom, an alkyl group having at most 20 carbon atoms, which may have an etheric oxygen atom, an alkoxycarbonyl group having at most 15 carbon atoms, or CH₂R¹² wherein R¹² is an alkoxycarbonyl group having at most 15 carbon atoms), COOR¹³ (wherein R¹³ is a hydrogen atom or an alkyl group having at most 10 carbon atoms), a sulfonic group, an amino group, an epoxy group, a trialkoxysilyl group or a cyano group. Specific examples of R¹¹ may, for example, be the same as those of the above R³. Such a functional group is preferably OR¹¹ or COOR¹³, and in such a case, the substitutional rate of the functional group in the fluoropolymer (A) (the proportion of the total of OR³ in the formula (1) and OR¹¹, or OR³ and COOR¹³ wherein each of R³, R¹¹ and R¹³ is other than a hydrogen atom against the total of OR³ and OR¹¹ or COOR¹³) is preferably from 5 to 100 mol %, more preferably from 10 to 80 mol %, particularly preferably from 10 to 50 mol %.

The group having a functional group-containing side chain may, for example, be a monovalent organic group such as a functional group-containing alkyl group, a functional group-containing fluoroalkyl group, a functional group-containing alkoxy group or a functional group-containing fluoroalkoxy group. The part where the functional groups are excluded from the group having a functional group-containing side chain preferably has at most 8 carbon atoms, particularly preferably has at most 6 carbon atoms.

The functional group in Q is preferably at least one member selected from the group consisting of a hydroxyl group, SO₃H, a methoxy group, a trifluoromethoxy group, Ot-C₄H₉, CH₂OCH₃, OCH₂OCH₃, CH₂OC₂H₅, OCH₂OC₂H₅, CH₂OCH₂C₃, CH₂OC₂H₄OCH₃, a 2-tetrahydropyranyl group, COOH, COO(t-C₄H₉), CH₂COOH, OCH₂COOH, CH₂COO(t-C₄H₉), OCH₂COO(t-C₄H₉), COO(2-methyladamant-2-yl), CH₂COO(2-methyladamant-2-yl), OCH₂COO(2-methyladamant-2-yl) and groups represented by the above [1] (represented by the form of —OR³ in order to define the bonding position). More preferred is at least one member selected from the group consisting of a hydroxyl group, OCH₂OCH₃, COOH, COO(t-C₄H₉), OCH₂COO(t-C₄H₉) and OCH₂COO(2-methyladamant-2-yl).

In the above formula (1) , in a case where OR³ is an acidic group such as a case where R³ is a hydrogen atom, it is possible to block the acidic group in the monomer represented by the formula (1), a reaction precursor of the fluorocopolymer formed by cyclopolymerization represented by the formula (1) or a fluorocopolymer containing monomer units formed by cyclopolymerization of the fluorinated diene represented by the formula (1) by means of a known method such as Williamson's synthesis and is thereby converted to a blocked acidic group, whereby it is possible to improve or adjust the functions of the fluorocopolymer, such as dry etching properties, heat resistance, solubility in the development treatment solution. Here, the blocked acidic group is a group capable of being converted to an acidic group upon reaction with an acid.

The blocked acidic group is preferably a blocked acidic group obtained by substituting hydrogen atoms in an acidic hydroxyl group with an alkyl group, an alkoxycarbonyl group, an acyl group or an ether group having a cyclic aliphatic hydrocarbon group. In a case where the acidic group is a carboxylic acid group or a sulfonic group, a blocking agent such as an alkanol may be reacted to substitute the hydrogen atoms in the acidic group with alkyl groups thereby to obtain a blocked acidic group.

Specific examples of R³ as a blocked acidic group include a methoxymethyl group, an ethoxymethyl group, a 2-methoxyethoxymethyl group, COO(t-C₄H₉), CH(CH₃)OC₂H₅ and a 2-tetrahydropyranyl group, and further the following groups.

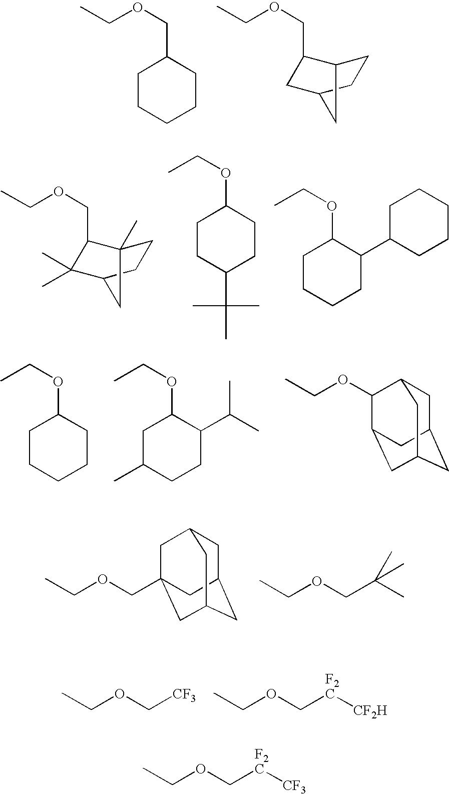

Further, it is possible to introduce the following huge blocked acidic group having at least 20 carbon bottom

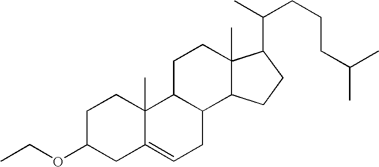

Specific examples of an effective reagent as the blocking agent are disclosed in Handbook of Reagents for Organic Synthesis: Activating Agents and Protecting Groups, edited by A. J. Pearson and W. R. Roush, John Wiley & Sons (1999).

The following compounds may be mentioned as specific examples of the fluorinated diene (1) in the present invention, but the diene is not limited thereto.

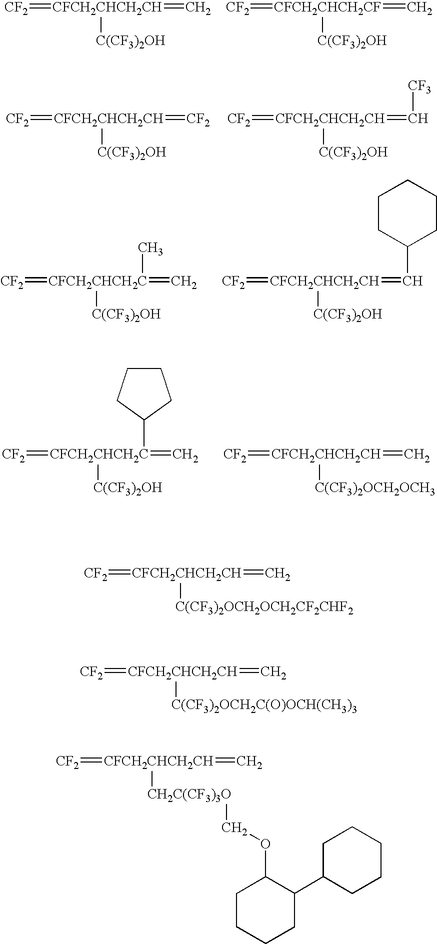

In the fluorocopolymer (A) of the present invention formed by copolymerization of the fluorinated diene (1) and the fluorinated diene (2), the fluorinated diene (1) is considered to be cyclopolymerized and present as any of the monomer units represented by the following formulae (a) to (c). Here, as described hereinafter, an acidic group in such a monomer unit may be blocked and converted to a blocked acidic group.

In other words, the fluorocopolymer (A) of the present invention may be considered as a copolymer having a structure containing units derived from at least one monomer unit selected from the group consisting of a monomer unit (a), a monomer unit (b) and a monomer unit (c). Here, the main chain of the cyclic polymer means a carbon chain constituted by four carbon atoms constituting polymerizable unsaturated double bonds.

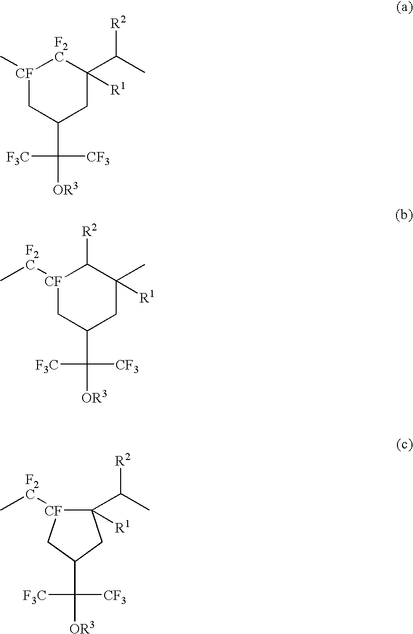

On the other hand, in the fluorocopolymer (A) of the present invention formed by copolymerization of the fluorinated diene (1) and the fluorinated diene (2), the fluorinated diene (2) is considered to be cyclopolymerized and present as any of the monomer units represented by the following formula (d) to (f). Here, a groups in the monomer unit may be modified. In other words, the fluorocopolymer (A) of the present invention may be considered as a copolymer having a structure containing units derived from at least one monomer unit selected from the group consisting of a monomer unit (d), a monomer unit (e) and a monomer unit (f).

Here, the main chain of the cyclic polymer means a carbon chain constituted by four carbon atoms constituting polymerizable unsaturated double bonds.

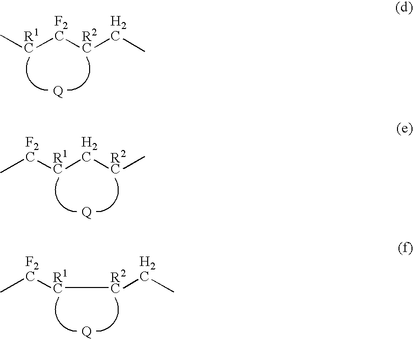

In the present invention, the proportion of the units derived from a monomer unit formed by cyclopolymerization of the fluorinated diene (1) in the fluorocopolymer (A) is preferably from 5 mol % to 95 mol %, more preferably from 10 mol % to 90 mol %. Further, the proportion of the units derived from a monomer unit formed by cyclopolymerization of the fluorinated diene (2) in the fluorocopolymer (A) is preferably from 5 mol % to 95 mol %, more preferably from 10 mol % to 90 mol %.

Further, in the present invention, a fluorocopolymer (B) having units derived from a monomer unit formed by cyclopolymerization of the above fluorinated diene (1) and units derived from a monomer unit formed by polymerization of an acrylic monomer represented by the following formula (3) (hereinafter referred to as an acrylic monomer (3)) can be obtained.
CH₂═CR⁸C(O)OR⁹ (3)

In the formula (3), R⁸ is a hydrogen atom, a fluorine atom, an alkyl group having at most 3 carbon atoms or a fluoroalkyl group having at most 3 carbon atoms, and preferred is a hydrogen atom, a fluorine atom, a methyl group or a trifluoromethyl group in view of availability.

R⁹ is an alkyl group having at most 20 carbon atoms, provided that the alkyl group constituting R⁹ may have some or all of its hydrogen atoms substituted by fluorine atoms or hydroxyl groups and may have an etheric oxygen atom or an ester bond. R⁹ is particularly preferably an alkyl group having at most 6 carbon atoms.

Accordingly, the acrylic monomer (3) is particularly preferably a monomer wherein R⁸ is a hydrogen atom, a fluorine atom, a methyl group or a trifluoromethyl group, and R⁹ is an alkyl group having at most 6 carbon atoms.

Specific examples of the acrylic monomer (3) include the following acrylates:
CH₂═CH—CO₂CH(CF₃) (CH₃),
CH₂═CH—CO₂CH(CF₃)₂,
CH₂═CH—CO₂C(CF₃)(CH₃)₂,
CH₂═CH—CO₂C(CF₃)₂(CH₃),
CH₂═CH—CO₂C(CF₃)₃,
CH₂═CH—CO₂CH₃,
CH₂═CF—CO₂CH(CH₃)₂,
CH₂═CF—CO₂CH (CF₃)(CH₃),
CH₂═CF—CO₂CH(CF₃)₂,
CH₂═CF—CO₂C(CH₃)₃,
CH₂═CF—CO₂C(CF₃)(CH₃)₂,
CH₂═CF—CO₂C(CF₃)₂(CH₃),
CH₂═CF—CO₂C(CF₃)₃,
CH₂═CF—CO₂CH₃,
CH₂═C(CH₃)—CO₂CH(CF₃)(CH₃),
CH₂═C(CH₃)—CO₂CH(CF₃)₂,
CH₂═C(CH₃)—CO₂C(CF₃)(CH₃)2,
CH₂═C(CH₃)—CO₂C(CF₃)₂(CH₃),
CH₂═C(CH₃)—CO₂C(CF₃)₃,
CH₂═C (CH₃)—CO₂CH₃,
CH₂═C(CF₃)—CO₂CH(CH₃)₂,
CH₂═C(CF₃)—CO₂CH(CF₃) (CH₃),
CH₂═C(CF₃)—CO₂CH(CF₃)₂,
CH₂═C(CF₃)—CO₂C(CH₃)₃,
CH₂═C(CF₃)—CO₂C(CF₃)(CH₃)₂,
CH₂═C(CF₃)—CO₂C(CF₃)₂(CH₃),
CH₂═C(CF₃)—CO₂C(CF₃)₃,
CH₂═C(CF₃)—CO₂CH₃,
CH₂═C(CH₃)—CO₂CH₂CH(CH₃)CH₂CH₂CH₂CH₃, CH₂═C(CH₃)—CO₂CH₂(CH (CH₃))₃H,

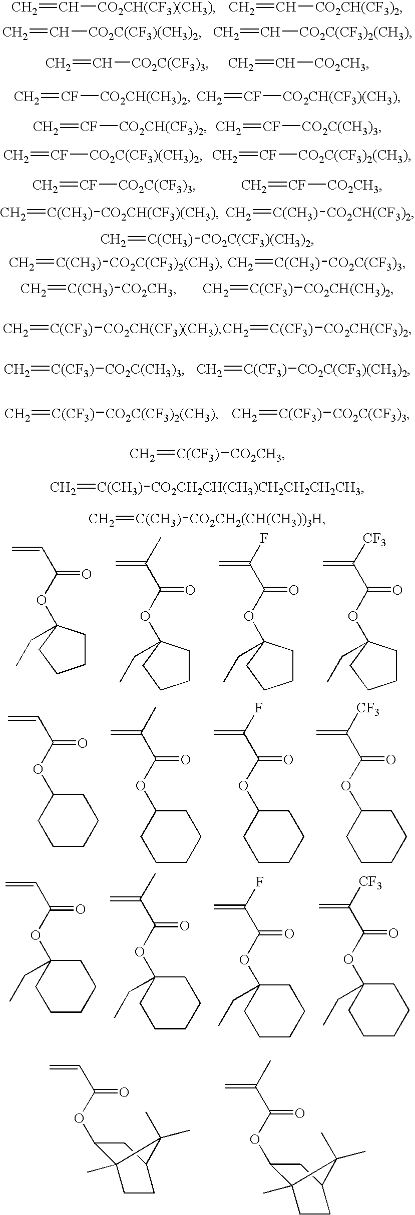

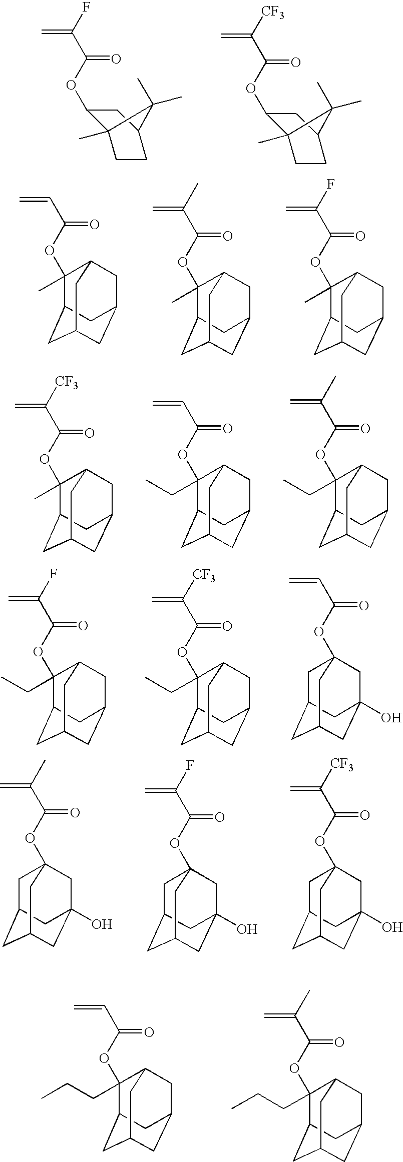

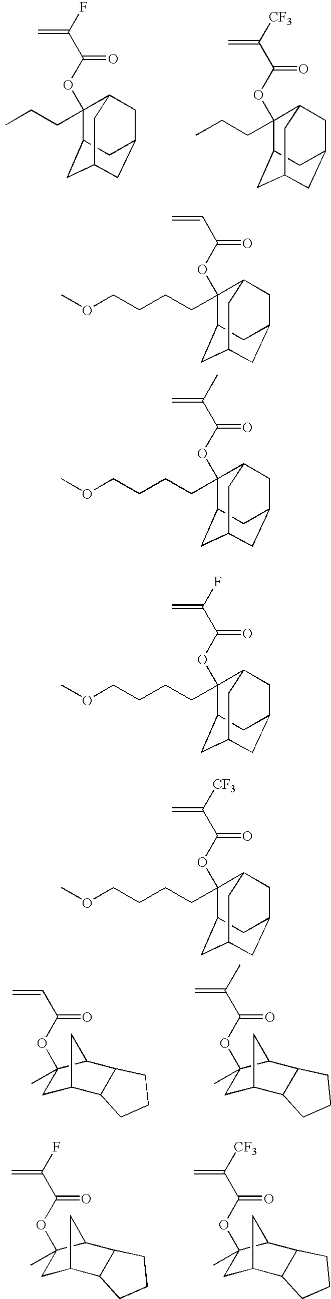

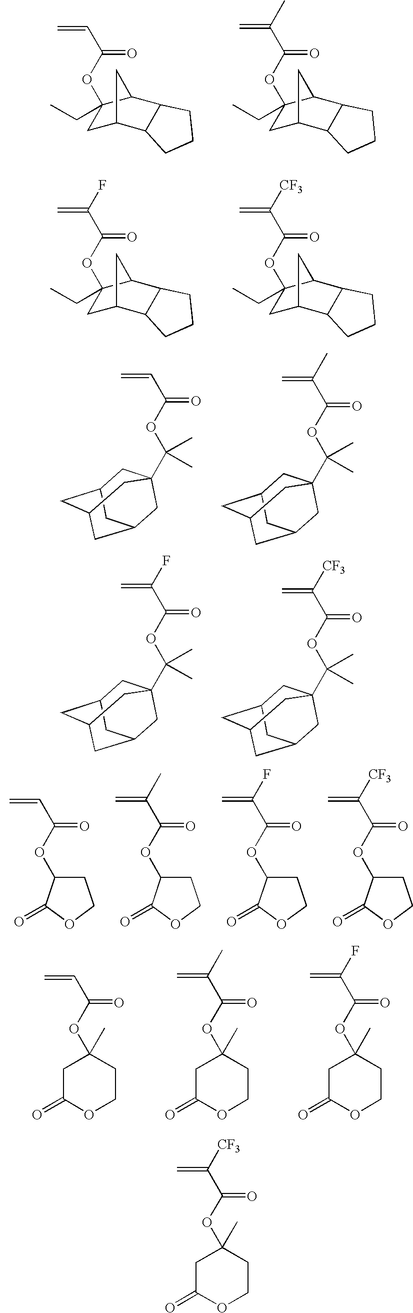

Further, the acrylic monomer (3) may be obtained by bonding CH₂═CR⁸C(O)OH and R⁹OH by esterification. Accordingly, acrylic monomers (3) having various structures can be easily prepared.

In the fluorocopolymer (B) of the present invention also, the fluorinated diene (1) is considered to be cyclopolymerized and present as any of monomer units represented by the above formulae (a) to (c). Here, as described hereinafter, an acidic group in such a monomer unit may be blocked and converted to a blocked acidic group. In other words, the fluorocopolymer (B) of the present invention may be considered as a copolymer having a structure containing units derived from at least one monomer unit selected from the group consisting of the monomer unit (a), the monomer unit (b) and the monomer unit (c).

In the present invention, the proportion of the units derived from a monomer unit formed by cyclopolymerization of the fluorinated diene (1) in the fluorocopolymer (B) is preferably from 5 mol % to 95 mol %, more preferably from 10 mol % to 95 mol %.

Further, in the fluorocopolymer (B), a group in the monomer unit formed by polymerization of the acrylic monomer (3) may be modified. Further, in the fluorocopolymer (B), as the monomer unit formed by polymerization of the acrylic monomer (3), a plural types of monomer units differing in one or both of R⁸ and R⁹ may be present.

In the present invention, the proportion of the units derived from a monomer unit formed by polymerization of the acrylic monomer (3) in the fluorocopolymer (B) is preferably from 5 mol % to 95 mol %, more preferably from 10 mo % to 80 mol %, particularly preferably from 15 mol % to 60 mol %.

The fluorocopolymer (A) and the fluorocopolymer (B) contain, as essential components, units derived from a monomer unit formed by cyclopolymerization of the fluorinated diene (1) and units derived from a monomer unit formed by cyclopolymerization of the fluorinated diene (2), and units derived from a monomer unit formed by cyclopolymerization of the fluorinated diene (1) and units derived from a monomer unit formed by polymerization of the acrylic monomer (3), respectively. Here, they may contain all of the units derived from the above three types of monomer units. Further, they may contain monomer units derived from another radical polymerizable monomer (hereinafter referred to as another monomer) within a range not to impair the characteristics. The proportion of such another monomer unit is preferably at most 50 mol %, particularly preferably at most 15 mol %.

Such another monomer may, for example, be an α-olefin such as ethylene, propylene or isobutylene, a fluorinated olefin such as tetrafluoroethylene or hexafluoropropylene, a fluorinated cyclic monomer such as perfluoro(2,2-dimethyl-1,3-dioxole), a cyclopolymerizable perfluorinated diene such as perfluoro(butenyl vinyl ether), a hydrofluorinated diene such as 1,1,2,3,3-pentafluoro-4-hydroxy-4-trifluoromethyl-1,6-heptadiene or 1,1,2-trifluoro-4-[3,3,3-trifluoro-2-hydroxy-2-trifluoromethylpropyl]-1,6-heptadiene, an acrylate such as methyl acrylate or ethyl methacrylate, a vinyl ester such as vinyl acetate, vinyl benzoate or vinyl adamantate, a vinyl ether such as ethyl vinyl ether or cyclohexyl vinyl ether, a cyclic olefin such as cyclohexene, norbornene or norbornadiene, maleic anhydride, or vinyl chloride.

Such another monomer is preferably at least one member selected from the group consisting of an a-olefin, a fluorinated cyclic monomer, a hydrofluorinated diene, an acrylate, a vinyl ester, a vinyl ether and a cyclic olefin. More preferably, it is at least one member selected from the group consisting of a fluorinated cyclic monomer, a hydrofluorinated diene, an acryl ester, a vinyl ester and a cyclic olefin.

The fluorocopolymer (A) and the fluorocopolymer (B) (hereinafter sometimes generically referred to as a fluorocopolymer) of the present invention are produced by radical copolymerization of the fluorinated diene (1) with the fluorinated diene (2) or the acrylic monomer (3) in the presence of a polymerization initiating source. The polymerization initiating source is not particularly limited so long as it is capable of letting the polymerization reaction proceed radically, and it may, for example, be a radical-generating agent, light or ionizing radiation. A radical-generating agent is particularly preferred, and it may, for example, be a peroxide, an azo compound or a persulfate. A radical-generating agent containing a fluorine atom in its molecule is more referred. Specific examples of a preferred radical-generating agent include azoisobisbutyronitrile, benzoyl peroxide, diisopropyl peroxydicarbonate, di-t-butyl peroxydicarbonate, t-butyl peroxypivarate, perfluorobutyryl peroxide and perfluorobenzoyl peroxide.

The radical polymerization method is also not particularly limited, and it may, for example, be so-called bulk polymerization wherein a monomer is subjected to polymerization as it is, solution polymerization which is carried out in a fluorohydrocarbon, a chlorohydrocarbon, a fluorochlorohydrocarbon, an alcohol, a hydrocarbon or other organic solvent, which is capable of dissolving the monomers, suspension polymerization which is carried out in an aqueous medium in the absence or presence of a suitable organic solvent, or emulsion polymerization which is carried out in an aqueous medium in the presence of an emulsifier. In the case of solution polymerization, the solvent is not limited so long as it is a solvent capable of dissolving the monomers, the initiator, etc., and it may be selected considering the molecular weight of the aimed fluorocopolymer, the polymerization temperature, etc.

The organic solvent to be used as a solvent at the time of the polymerization is not limited to one type, but a solvent mixture of a plural types of organic solvents may be employed. Specifically, it may, for example, be an aliphatic hydrocarbon such as pentane, hexane or heptane, a hydrocarbon alcohol such as methanol, ethanol, n-propanol, isopropanol or t-butanol, a hydrocarbon ketone such as acetone, methyl ethyl ketone, methyl isobutyl ketone or cyclohexanone, a hydrocarbon ether such as dimethyl ether, diethyl ether, methyl ethyl ether, methyl t-butyl ether, diethylene glycol dimethyl ether or tetraethylene glycol dimethyl ether, an alicyclic hydrocarbon ether such as tetrahydrofuran or 1,4-dioxane, a nitrile such as acetonitrile, a hydrocarbon ester such as methyl acetate, ethyl acetate, propyl acetate, isopropyl acetate, butyl acetate, t-butyl acetate, methyl propionate or ethyl propionate, an aromatic hydrocarbon such as toluene or xylene, a chlorohydrocarbon such as methylene chloride, chloroform or carbon tetrachloride, a chlorofluorohydrocarbon such as R-113, R-113a, R-141b, R-225ca or R-225cb, a fluorohydrocarbon such as 1,1,1,2,2,3,3,4,4,5,5,6,6-tridecafluorohexane or 1,1,1,2,2,3,3,4,4-nonafluorohexane, a fluorohydrocarbon ether such as methyl 2,2,3,3-tetrafluoropropyl ether or methyl (perfluorobutyl) ether, or a fluorohydrocarbon alcohol such as 2,2,2-trifluoroethanol, 1,1,1,3,3,3-hexafluoroisopropanol, 2,2,3,3-tetrafluoropropanol or 2,2,3,3,4,4,5,5-octafluoropentanol, but the solvent is not limited thereto.

The organic solvent to be used as a solvent at the time of the polymerization is preferably at least one member selected from the group consisting of a hydrocarbon alcohol, a hydrocarbon ketone, a hydrocarbon ether, a cyclic aliphatic hydrocarbon ether, a nitrile, a hydrocarbon ester, an aromatic hydrocarbon, a chlorohydrocarbon, a chlorofluorohydrocarbon, a fluorohydrocarbon, a fluorohydrocarbon ether and a fluorohydrocarbon alcohol.

The polymerization temperature and pressure are also not particularly limited, but it is preferred to properly set them taking into consideration various factors such as the boiling point of the monomers, the prescribed heating source, removal of the polymerization heat, etc. For example, suitable temperature setting can be carried out between 0° C. and 200° C., and practically suitable temperature setting can be carried out within a range of from room temperature to about 100° C. Further, the polymerization pressure may be a reduced pressure or an elevated pressure, and practically, the polymerization can properly be carried out within a range of from about 1 kPa to about 100 MPa, preferably from about 10 kPa to about 10 MPa.

The present invention also provides a resist composition comprising the fluorocopolymer (A) or the fluorocopolymer (B), an acid-generating compound which generates an acid under irradiation with light, and an organic solvent.

The acid-generating compound which generates an acid under irradiation with light of the present invention is a compound which will be decomposed and generate an acid under irradiation with light, more specifically under irradiation with active light beams. By the acid generated by irradiation with active light beam, some or all of the blocked acidic groups which exist in the fluorocopolymer are cleaved (deblocked). As a result, the exposed portions of the resist film will become readily soluble by an alkali developer, whereby a positive resist pattern will be formed by the alkali developer.

The acid-generating compound to be used for the resist composition of the present invention may be an acid-generating compound to be used for e.g. a photoinitiator for cationic photopolymerization, a photoinitiator for radical photopolymerization, a photodecolorizer for colorants, a photoalterant, or an acid-generating agent to be used for a microphotoresist which generates an acid by active light beams such as ultraviolet rays, far ultraviolet rays such as a KrF excimer laser beam or an ArF excimer laser beam, vacuum ultraviolet rays such as a F₂ excimer laser beam, electron rays, X-rays, molecular beams or ion beams.

In the present invention, preferred is an acid-generating compound which generates an acid under irradiation with active light beams having a wavelength of at most 250 nm, more preferably at most 200 nm, so as to form a fine resist pattern.

In the present invention, the concept of the active light beams widely includes radioactive rays.

The acid-generating compound is preferably at least one member selected from the group consisting of an onium salt, a halogenated compound, a diazoketone compound, a sulfone compound and a sulfonic acid compound. Examples of the acid-generating compound include the following compounds.

The onium salt may, for example, be an iodonium salt, a sulfonium salt, a phosphonium salt, a diazonium salt or a pyridinium salt. Specific examples of a preferred onium salt include diphenyliodonium triflate, diphenyliodoniumpyrene sulfonate, diphenyliodonium hexafluoroantimonate, diphenyliodoniumdodecylbenzene sulfonate, bis(4-tert-butylphenyl)iodonium triflate, bis(4-tert-butylphenyl)iodonium dodecylbenzene sulfonate, triphenylsulfonium triflate, triphenylsulfonium nonanate, triphenylsulfoniumperfluorooctane sulfonate, triphenylsulfonium hexafluoroantimonate, trifluorosulfonium naphthalenesulfonate, triphenylsulfonium trifluoromethanesulfonate, triphenylsulfonium camphorsulfonium, 1-(naphthylacetomethyl)thiolanium triflate, cyclohexylmethyl(2-oxocyclohexyl)sulfonium triflate, dicyclohexyl(2-oxocyclohexyl)sulfonium triflate, dimethyl(4-hydroxynaphthyl)sulfonium tosylate, dimethyl(4-hydroxynaphthyl)sulfonium dodecylbenzene sulfonate, dimethyl(4-hydroxynaphthyl)sulfonium naphthalene sulfonate, triphenylsulfonium camphor sulfonate, (4-hydroxyphenyl)benzylmethylsulfonium toluene sulfonate, (4-methoxyphenyl)phenyliodonium trifluoromethanesulfonate and bis(t-butylphenyl)iodonium trifluoromethanesulfonate.

The halogenated compound may, for example, be a haloalkyl group-containing hydrocarbon compound or a haloalkyl group-containing heterocyclic compound. Specifically, it may, for example, be a (trichloromethyl)-s-triazine derivative such as phenyl-bis(trichloromethyl)-s-triazine, methoxyphenyl-bis(trichloromethyl)-s-triazine or naphthyl-bis(trichloromethyl)-s-triazine, or 1,1-bis(4-chlorophenyl)-2,2,2-trichloroethane.

The sulfone compound may, for example, be β-ketosulfone, β-sulfonylsulfone or an α-diazo compound of such a compound. Specifically, it may, for example, be 4-trisphenacylsulfone, mesitylphenacylsulfone or bis(phenylsulfonyl)methane. The sulfonic acid compound may, for example, be an alkylsulfonic acid ester, an alkylsulfonic acid imide, a haloalkylsulfonic acid ester, an arylsulfonic acid ester or an iminosulfonate. Specifically, it may, for example, be benzoin tosylate or 1,8-naphthalene dicarboxylic acid imide triflate.

Further, a diazodisulfone, a diazoketosulfone, an iminosulfonate, a disulfone, etc. may also be suitably used as the acid-generating compound.

Further, the acid-generating compound may, for example, be preferably a polymer compound having groups which generate an acid under irradiation with active light beams in its main chain or in its side chains.

The polymer compound may, for example, be a polymer compound having, as groups which generate an acid under irradiation with active light beams, e.g. an aliphatic alkylsulfonium group having a 2-oxocyclohexyl group or a N-hydroxysuccinimide sulfonate group.

These acid-generating compounds may be used alone or in combination as a mixture of two or more of them. Further, they may be combined with a proper sensitizer.

In the resist composition of the present invention, the organic solvent is not particularly limited so long as it is an organic solvent capable of sufficiently dissolving the fluorocopolymer and the acid-generating compound and capable of forming a uniform coating film by applying the solution by e.g. spin coating, cast coating or roll coating.

Such an organic solvent may, for example, be an alcohol such as methyl alcohol, ethyl alcohol or diacetone alcohol, a ketone such as acetone, methyl isobutyl ketone, cyclohexanone, cyclopentanone, 2-heptanone, N-methylpyrrolidone or γ-butyrolactone, an ester such as propylene glycol monomethyl ether acetate, propylene glycol monomethyl ether propionate, propylene glycol monoethyl ether acetate, carbitol acetate, methyl 3-methoxypropionate, ethyl 3-ethoxypropionate, methyl β-methoxyisobutyrate, ethyl butyrate, propyl butyrate, methyl isobutyl ketone, ethyl acetate, 2-ethoxyethyl acetate, isoamyl acetate, methyl lactate or ethyl lactate, an aromatic hydrocarbon such as toluene or xylene, a glycol mono- or dialkyl ether such as propylene glycol monomethyl ether, propylene glycol monoethyl ether, ethylene glycol monoisopropyl ether, diethylene glycol monomethyl ether, diethylene glycol dimethyl ether or propylene glycol monomethyl ether, or N,N-dimethylformamide or N,N-dimethylacetamide.

As the organic solvent, the above solvents may be used alone or in combination as a mixture of two or more of them. The organic solvent is preferably at least one member selected from the group consisting of an alcohol, a ketone, an ester, an aromatic hydrocarbon, a glycol mono- or dialkyl ether and an amide. It is more preferably at least one member selected from the group consisting of an alcohol, a ketone, an ester and a glycol mono- or dialkyl ether. Since the moisture contained in the organic solvent will influence the solubility of the respective components in the resist composition, coating properties on a substrate to be coated, the storage stability, etc., the moisture content is preferably low.

The proportions of the respective components in the resist composition of the present invention are usually such that the acid-generating compound is from 0.1 to 20 parts by mass and the organic solvent is from 50 to 2,000 parts by mass, per 100 parts by mass of the fluorocopolymer. Preferably, the acid-generating compound is from 0.1 to 10 parts by mass and the organic solvent is from 100 to 1,000 parts by mass, per 100 parts by mass of the fluorocopolymer. When the amount of the acid-generating compound is at least 0.1 part by mass, a sufficient sensitivity and developability can be provided, and when it is at most 10 parts by mass, a sufficient transparency to radiation is retained, whereby a more accurate resist pattern can be obtained.

In the resist composition of the present invention, e.g. an acid-cleavable additive to improve the pattern contrast, a surfactant to improve the coating property, a nitrogen-containing basic compound to adjust the acid-generating pattern, an adhesion-assisting agent to improve the adhesion to a substrate or a storage stabilizer to enhance the storage stability of the composition, may be optionally incorporated. Further, the resist composition of the present invention is preferably employed in such a manner that the respective components are uniformly mixed, followed by filtration by means of a filter of from 0.1 to 2 μm.

The resist composition of the present invention is applied on a substrate such as a silicon wafer, followed by drying to form a resist film. As the coating method, spin coating, cast coating or roll coating may, for example, be employed. The formed resist film will be irradiated with active light beams through a mask having a pattern drawn thereon, followed by development treatment to form the pattern.

The active light beams for the irradiation may, for example, be ultraviolet rays such as g-line having a wavelength of 436 nm or i-line having a wavelength of 365 nm, or far ultraviolet rays such as a KrF excimer laser beam having a wavelength of 248 nm or an ArF excimer laser beam having a wavelength of 193 nm, or vacuum ultraviolet rays such as a F₂ excimer laser beam having a wavelength of 157 nm. The resist composition of the present invention is a resist composition which is useful for an application where ultraviolet rays having a wavelength of at most 250 nm, particularly for ultraviolet rays having a wavelength of at most 200 nm (ArF excimer laser beam) or vacuum ultraviolet rays (F₂ excimer laser beam), are used as the light source. In addition, it is such a resist composition that is useful also to an exposure using a so-called immersion technique for improvement of the resolution by utilizing the large refractive index of e.g. water, an organic compound containing fluorine atoms, etc. The resist composition of the present invention is particularly preferred for an application employing a F₂ excimer laser beam capable of forming finer patterns, and in a case where an ArF excimer laser beam is employed as a light source, an application in combination with exposure employing immersion technique.

As the development treatment solution, various alkali aqueous solutions are employed. As such an alkali material, sodium hydroxide, potassium hydroxide, ammonium hydroxide, tetramethylammonium hydroxide or triethylamine may, for example, be mentioned.

### EXAMPLES

Now, the present invention will be described in detail with reference to Examples, but it should be understood that the present invention is by no means restricted thereto.

Abbreviations used in the following Examples are as follows. THF: tetrahydrofuran, AIBN: azobisisobutyronitrile, BPO: benzoyl peroxide, PSt: polystyrene, R225: dichloropentafluoropropane (solvent), PFB: perfluorobutyryl peroxide and PFBPO: perfluorobenzoyl peroxide.

### PREPARATION EXAMPLE 1

### Preparation of [CF₂═CFCH₂CH(C(CF₃)₂OH)CH₂CH═CH₂]

Into a 1 L glass reactor, 500 g of CF₂ClCFClI, 344 g of CH₂═CHC(CF₃)₂OH and 32.6 g of BPO were put and heated at 95° C. for 71 hours. The reaction crude liquid was distilled under reduced pressure to obtain 544 g of CF₂ClCFClCH₂CHI(C(CF₃)₂OH) (55-58° C./0.2 kPa).

344 g of the above prepared CF₂ClCFClCH₂CHI(C(CF₃)₂OH) and 1.7 L of dehydrated THF were put in a 5 L glass reactor and cooled to −70° C. 1.8 L of a 2M-THF solution of CH₂═CHCH₂MgCl was dropwise added thereto over a period of 4 hours.

After the temperature was raised to 0° C. and stirring was carried out for 16 hours, 1.6 L of an aqueous saturated ammonium chloride solution was added thereto, and the temperature was raised to room temperature. The reaction solution was subjected to liquid separation, and the organic layer was concentrated by an evaporator and then distilled under reduced pressure to obtain 287 g of CF₂ClCFClCH₂CH(C(CF₃)₂OH)CH₂CH═CH₂ (62-66° C./0.2 kPa). Into a 1 L glass reactor, 97 g of zinc and 300 g of water were put and heated at 90° C. 287 g of the above prepared CF₂ClCFClCH₂CH(C(CF₃)₂OH) CH₂CH═CH₂ was dropwise added thereto, followed by stirring for 24 hours. 70 mL of hydrochloric acid was dropwise added to the reaction solution, followed by stirring for 2 hours, and the reaction solution was subjected to filtration and liquid separation, followed by distillation under reduced pressure to obtain 115 g of CF₂═CFCH₂CH(C(CF₃)₂OH)CH₂CH═CH₂ (53-54° C./1 kPa, hereinafter referred to as monomer 1).

NMR spectrum of monomer 1

¹H-NMR (399.8 MHz, solvent:CDCl₃, standard: tetramethylsilane) δ(ppm) : 2.53 (m, 5H), 3.49 (m, 1H) 5.15(m, 2H), 5.79(m, 2H)

¹⁹F-NMR (376.2 MHz, solvent: CDCl₃, standard: CFCl₃) δ(ppm): −73.6(m, 6F), −104.1(m, 1F), −123.1(m, 1F), −175.4(m, 1F).

### Example 1

1.50 g of monomer 1 prepared in Preparation Example 7, 0.40 g of CF₂═CFCH₂C(C(═O)OC(CH₃)₃)CH₂CH═CH₂ (hereinafter referred to as monomer 2-1) and 0.104 g of ethyl acetate were charged into a pressure resistant reactor made of glass and having an internal capacity of 50 mL. Then, 2.49 g of a R225 solution containing 3 mass % of PFB as a polymerization initiator was added. The interior of the system was freeze-deaerated, and then the reactor was sealed, followed by radical polymerization for 18 hours in a constant temperature shaking bath (20° C.). After the polymerization, the reaction solution was dropped into a large excess amount of hexane to precipitate the polymer, followed by vacuum drying at 100° C. for 40 hours. As a result, 1.75 g of amorphous fluorocopolymer 1 having a fluorinated cyclic structure in its main chain was obtained. As the molecular weight of fluorocopolymer 1 measured by GPC employing THF as a solvent and calculated as PSt, the number average molecular weight (Mn) was 13,300, and the weight average molecular weight (Mw) was 25,600, and Mw/Mn=1.93. Tg measured by differential scanning calorimetry (DSC) was 123° C., and the polymer was white and powdery at room temperature. Fluorocopolymer 1 had a polymer composition calculated by ¹⁹F-NMR and ¹H-NMR measurement comprising repeating units derived from monomer 1/repeating units derived from monomer 2-1=72/28 mol %. Fluorocopolymer 1 was soluble in acetone, THF, methanol and R225.

0.11 g of fluorocopolymer 1 and 0.0056 g of triphenylsulfonium triflate as an acid-generating compound were dissolved in 1.45 g of 2-heptanone, and the solution was filtered through a filter made of PTFE and having a pore diameter of 0.2 μm to produce a resist composition 1. This solution was spin-coated on a silicon substrate, followed by heat treatment at 90° C. for 90 seconds to form a resist film having a thickness of 0.13 μm. In an extreme ultraviolet spectrometer manufactured by Bunko-Keiki Co., LTD., the substrate having the above resist film formed, was placed, and light transmittances at wavelengths of 157 nm and 193 nm, corresponding to a F₂ excimer laser beam and an ArF excimer laser beam, respectively, were measured, whereupon they were 67% and 68%. Further, the same operation as above was carried out except that no triphenylsulfonium triflate was added, and the light transmittances at 157 nm and 193 nm were measured, whereupon they were 81% and 96%, respectively.

### Example 2

2.00 g of monomer 1, 0.106 g of t-butyl-2-fluoromethyl acrylate (hereinafter referred to as monomer 3-1), 0.39 g of ethyl acetate and 4.73 g of R225 were charged in a pressure resistant reactor made of glass and having an internal capacity of 20 mL. Then, 7.028 g of an R225 solution containing 3 mass % of PFB as a polymerization initiator was added. The interior of the system was freeze-deaerated, and then the reactor was sealed, followed by radical polymerization for 18 hours in a constant temperature shaking bath (20° C.). After the polymerization, the reaction solution was dropped into a large excess amount of hexane to reprecipitate the polymer, followed by vacuum drying at 90° C. for 50 hours. As a result, 1.71 g of amorphous fluorocopolymer 2 having a fluorinated cyclic structure in its main chain was obtained. As the molecular weight of fluorocopolymer 2 measured by GPC employing THF as a solvent and calculated as PSt, the number average molecular weight (Mn) was 16,400, the weight average molecular weight (Mw) was 42,000, and Mw/Mn═2.56. As measured by differential scanning calorimetry (DSC), Tg was 119° C., and the polymer was white and powdery at room temperature. Fluorocopolymer 2 had a polymer composition calculated by ¹⁹F-NMR and ¹H-NMR measurement comprising repeating units derived from monomer 1/repeating units derived from monomer 3-1=88/12 mol %. Fluorocopolymer 2 was soluble in acetone, THF, ethyl acetate, methanol and R225, and insoluble in perfluoro-n-octane.

0.11 g of fluorocopolymer 2 and 0.0056 g of triphenylsulfonium triflate as an acid-generating compound were dissolved in 1.45 g of 2-heptanone, and the solution was filtered through a filter made of PTFE and having a pore diameter of 0.2 μm to produce a resist composition 2. This solution was spin-coated on a silicon substrate, followed by heat treatment at 90° C. for 90 seconds to form a resist film having a thickness of 0.13 μm. In an extreme ultraviolet spectrometer manufactured by Bunko-Keiki Co., LTD., the substrate having the above resist film formed, was placed, and transmittances at wavelengths of 157 nm and 193 nm were measured, whereupon they were 70% and 69%, respectively. Further, the same operation as above was carried out except that no triphenylsulfonium triflate was added, and the light transmittances at 157 nm and 193 nm were measured, whereupon they were 84% and 97%, respectively.

### Example 3

In the same manner as in Example 1 except that 0.85 g of CF₂═CFCF₂C(CF₃) (OCH₂OCH₃)CH₂CH═CH₂ (hereinafter referred to as monomer 2-2) is used instead of monomer 2-1, that 2.0 g of monomer 1, 0.50 g of ethyl acetate, 6.32 g of the R225 solution containing 3 mass % of PFB are used, and that a pressure resistant reactor made of glass and having an internal capacity of 20 mL is used, fluorocopolymer 3 having repeating units derived from monomer 1 and repeating units derived from monomer 2-2 is obtained.

### Example 4

In the same manner as in Example 1 except that 0.76 g of CF₂═CFCH₂CH(CH₂C(CF₃) ₂OCH₂OCH₃)CH₂CH═CH₂ (hereinafter referred to as monomer 2-3) is used instead of monomer 2-1, that 3.00 g of monomer 1, 0.60 g of ethyl acetate and 12.53 g of the R225 solution containing 3 mass % of PFB are used, that 8.54 g of R225 is further added as a solvent, and that a pressure resistant reactor made of glass and having an internal capacity of 30 mL is used, fluorocopolymer 4 having repeating units derived from monomer 1 and repeating units derived from monomer 2-3 is obtained.

### Example 5

In the same manner as in Example 2 except that 0.26 g of 3-hydroxy-l-adamantyl methacrylate (hereinafter referred to as monomer 3-2) is used instead of monomer 3-1, that 4.00 g of monomer 1 and 6.39 g of ethyl acetate are used, that 0.160 g of PFBPO is used instead of the R225 solution containing 3 mass % of PFB as a polymerization initiator, and that the temperature in the constant temperature shaking bath is. 70° C., fluorocopolymer 5 having repeating units derived from monomer 1 and repeating units derived from monomer 3-2 is obtained.

### Example 6

In the same manner as in Example 2 except that 0.138 g of t-butyl-2-trifluoromethyl acrylate (hereinafter referred to as monomer 3-3) is used instead of monomer 3-1, fluorocopolymer 6 having repeating units derived from monomer 1 and repeating units derived from monomer 3-3 is obtained.

The fluorocopolymer of the present invention is useful for an application of forming fine patterns employing an ArF excimer laser beam or a F₂ excimer laser beam as a light source. Specifically, it is applicable to not only photoresists but also ion exchange resins, ion exchange membranes, fuel cells, various cell materials, optical fibers, electronic components, transparent film materials, agricultural vinyl films, adhesives, fiber materials, weather resistant coating compositions, etc.

The entire disclosure of Japanese Patent Application No. 2004-138230 filed on May 7, 2004 including specification, claims and summary is incorporated herein by reference in its entirety.

1. A fluorocopolymer (A) having units derived from a monomer unit formed by cyclopolymerization of a fluorinated diene represented by the following formula (1) and units derived from a monomer unit formed by cyclopolymerization of a functional group-containing fluorinated diene represented by the following formula (2) (provided that the fluorinated diene represented by the formula (1) is excluded):
CF₂═CFCH₂CH(C(CF₃)₂(OR³))CH₂CR¹═CHR² (1)
wherein each of R¹ and R² which are independent of each other, is a hydrogen atom or an alkyl group having at most 12 carbon atoms, and R³ is a hydrogen atom, an alkyl group having at most 20 carbon atoms, an alkoxycarbonyl group having at most 15 carbon atoms or CH₂R⁴ (wherein R⁴ is an alkoxycarbonyl group having at most 15 carbon atoms), provided that the alkyl group, the alkoxycarbonyl group or R⁴ constituting R³ may have some or all of its hydrogen atoms substituted by fluorine atoms and may have an etheric oxygen atom:
CF₂═CR⁶—Q—CR⁷═CH₂ (2)
wherein each of R⁶ and R⁷ which are independent of each other, is a hydrogen atom, a fluorine atom, an alkyl group having at most 3 carbon atoms, a fluoroalkyl group having at most 3 carbon atoms, or a cyclic aliphatic hydrocarbon group, and Q is an alkylene group, an oxyalkylene group, a fluoroalkylene group or a fluorooxyalkylene group, having a functional group or a functional group-containing side chain group.

2. A fluorocopolymer (B) having units derived from a monomer unit formed by cyclopolymerization of a fluorinated diene represented by the following formula (1) and units derived from a monomer unit formed by polymerization of an acrylic monomer represented by the following formula (3):
CF₂═CFCH₂CH(C(CF₃)₂(OR³))CH₂CR¹═CHR² (1)
wherein each of R¹ and R² which are independent of each other, is a hydrogen atom or an alkyl group having at most 12 carbon atoms, and R³ is a hydrogen atom, an alkyl group having at most 20 carbon atoms, an alkoxycarbonyl group having at most 15 carbon atoms or CH₂R⁴ (wherein R⁴ is an alkoxycarbonyl group having at most 15 carbon atoms), provided that the alkyl group, the alkoxycarbonyl group or R⁴ constituting R³, may have some or all of its hydrogen atoms substituted by fluorine atoms and may have an etheric oxygen atom:
CH₂═CR⁸C(O)OR⁹ (3)
wherein R⁸ is a hydrogen atom, a fluorine atom, an alkyl group having at most 3 carbon atoms, or a fluoroalkyl group having at most 3 carbon atoms, and R⁹ is an alkyl group having at most 20 carbon atoms, provided that the alkyl group constituting R⁹ may have some or all of its hydrogen atoms substituted by fluorine atoms or hydroxyl groups and may have an etheric oxygen atom or an ester bond.

3. The fluorocopolymer (A) according to claim 1, wherein in the formula (1), each of R¹ and R² which are independent of each other, is a hydrogen atom or a methyl group.

4. The fluorocopolymer (B) according to claim 2, wherein in the formula (1), each of R¹ and R² which are independent of each other, is a hydrogen atom or a methyl group.

5. The fluorocopolymer (A) according to claim l, wherein in the formula (1), R³ is at least one member selected from the group consisting of a hydrogen atom, a methyl group, a trifluoromethyl group, t-C₄H₉, CH₂OCH₃, CH₂OC₂H₅, CH₂OCH₂CF₃, CH₂OC₂H₄OCH₃, a 2-tetrahydropyranyl group, COOH, COO(t-C₄H₉), CH₂COOH, CH₂COO(t-C₄H₉), COO(2-methyladamant-2-yl), CH₂COO(2-methyladamant-2-yl) and the following groups (represented by the form of —OR³ in order to define the bonding position):

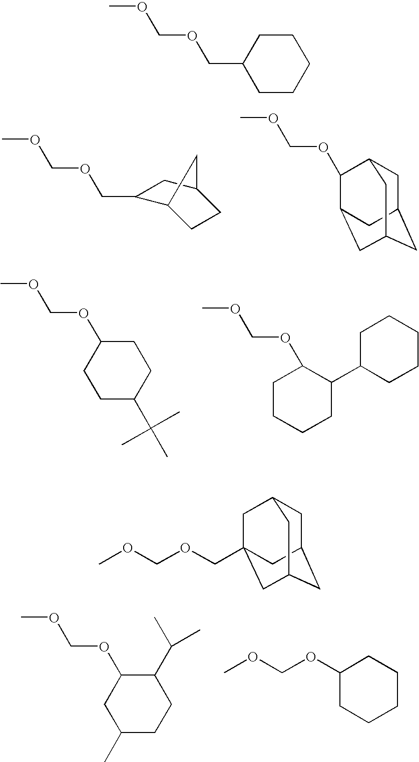

6. The fluorocopolymer (B) according to claim 2, wherein in the formula (1), R³ is at least one member selected from the group consisting of a hydrogen atom, a methyl group, a trifluoromethyl group, t-C₄H₉, CH₂OCH₃, CH₂OC₂H₅, CH₂OCH₂CF₃, CH₂OC₂H₄OCH₃, a 2-tetrahydropyranyl group, COOH, COO(t-C₄H₉), CH₂COOH, CH₂COO(t-C₄H₉), COO(2-methyladamant-2-yl), CH₂COO(2-methyladamant-2-yl) and the following groups (represented by the form of —OR³ in order to define the bonding position):

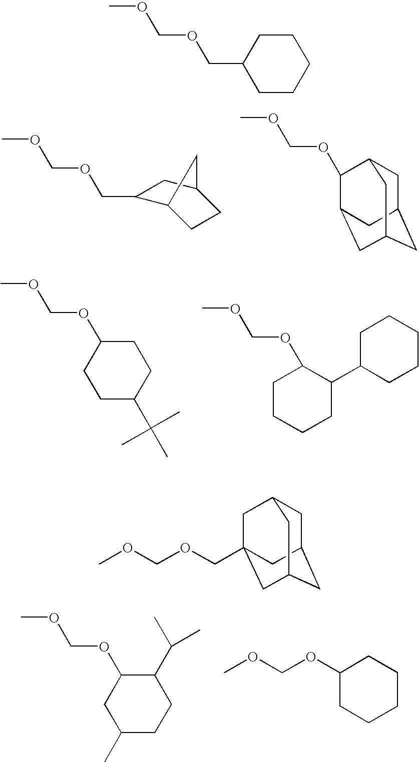

7. The fluorocopolymer (A) according to claim 1, wherein in the formula (2), each of R⁶ and R⁷ is a hydrogen atom, and the functional group in Q is a hydroxyl group, a methoxy group, a trifluoromethoxy group, CH₂OCH₃, OCH₂OCH₃, Ot-C₄H₉, CH₂OC₂H₅, OCH₂OC₂H₅, CH₂OCH₂CF₃, CH₂OC₂H₄OCH₃, a 2-tetrahydropyranyl group, COOH, COO(t-C₄H₉), CH₂COOH, OCH₂COOH, CH₂COO(t-C₄H₉), OCH₂COO(t-C₄H₉), COO(2-methyladamant-2-yl), CH₂COO(2-methyladamant-2-yl), OCH₂COO(2-methyladamant-2-yl) and the following groups (represented by the form of —OR³ in order to define the bonding position):

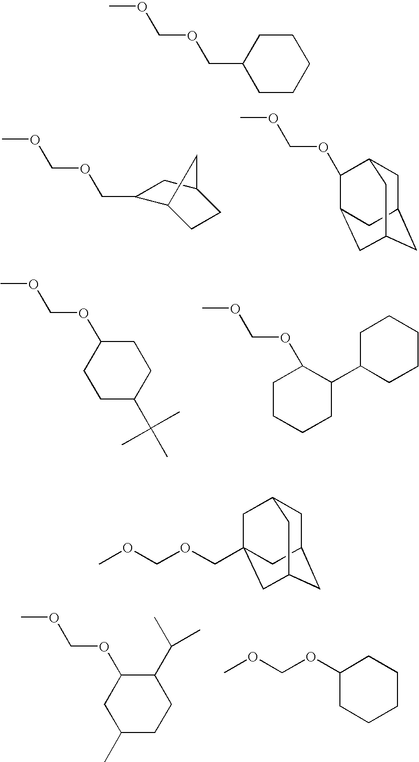

8. The fluorocopolymer (B) according to claim 2, wherein in the formula (3), R⁸ is a hydrogen atom, a fluorine atom, a methyl group or a trifluoromethyl group, and R⁹ is an alkyl group having at most 20 carbon atoms, provided that the alkyl group constituting R⁹ may have some or all of its hydrogen atoms substituted by fluorine atoms or hydroxyl groups, and the alkyl group constituting R⁹ may have some of its CH₂ groups substituted by oxygen atoms or carbonyl groups.

9. A method for producing the fluorocopolymer (A) as defined in claim 1, which comprises radical copolymerization of a fluorinated diene represented by the following formula (1) and a functional group-containing fluorinated diene represented by the following formula (2) (provided that the fluorinated diene represented by the formula (1) is excluded):
CF₂═CFCH₂CH(C(CF₃)₂(OR³))CH₂CR¹═CHR² (1)
wherein each of R¹ and R² which are independent of each other, is a hydrogen atom or an alkyl group having at most 12 carbon atoms, and R³ is a hydrogen atom, an alkyl group having at most 20 carbon atoms, an alkoxycarbonyl group having at most 15 carbon atoms or CH₂R⁴ (wherein R⁴ is an alkoxycarbonyl group having at most 15 carbon atoms), provided that the alkyl group, the alkoxycarbonyl group or R⁴ constituting R³ may have some or all of its hydrogen atoms substituted by fluorine atoms and may have an etheric oxygen atom:
CF₂═CR⁶—Q—CR⁷═CH₂ (2)
wherein each of R⁶ and R⁷ which are independent of each other, is a hydrogen atom, a fluorine atom, an alkyl group having at most 3 carbon atoms, a fluoroalkyl group having at most 3 carbon atoms, or a cyclic aliphatic hydrocarbon group, and Q is an alkylene group, an oxyalkylene group, a fluoroalkylene group or a fluorooxyalkylene group, having a functional group or a functional group-containing side chain group.

10. A method for producing the fluorocopolymer (B) as defined in claim 2, which comprises radical copolymerization of a fluorinated diene represented by the following formula (1) and an acrylic monomer represented by the following formula (3):
CF₂═CFCH₂CH(C(CF₃)₂(OR³))CH₂CR¹═CHR² (1)
wherein each of R¹ and R² which are independent of each other, is a hydrogen atom or an alkyl group having at most 12 carbon atoms, and R³ is a hydrogen atom, an alkyl group having at most 20 carbon atoms, an alkoxycarbonyl group having at most 15 carbon atoms or CH₂R⁴ (wherein R⁴ is an alkoxycarbonyl group having at most 15 carbon atoms), provided that the alkyl group, the alkoxycarbonyl group or R⁴ constituting R³ may have some or all of its hydrogen atoms substituted by fluorine atoms and may have an etheric oxygen atom:
CH₂═CR⁸C(O)OR⁹ (3)
wherein R⁸ is a hydrogen atom, a fluorine atom, an alkyl group having at most 3 carbon atoms, or a fluoroalkyl group having at most 3 carbon atoms, and R⁹ is an alkyl group having at most 20 carbon atoms, provided that the alkyl group constituting R⁹ may have some of its hydrogen atoms substituted by fluorine atoms or hydroxyl groups, and the alkyl group constituting R⁹ may have some of its CH₂ groups substituted by oxygen atoms or carbonyl groups.

11. The fluorocopolymer (A) according to claim 1, wherein the fluorinated diene represented by the formula (1) is any of fluorinated dienes represented by the following formulae:

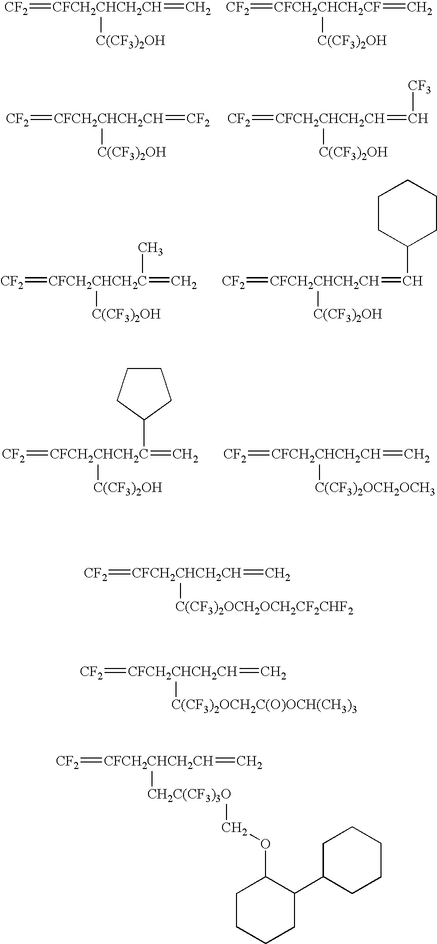

12. The fluorocopolymer (B) according to claim 2, wherein the fluorinated diene represented by the formula (1) is any of fluorinated dienes represented by the following formulae:

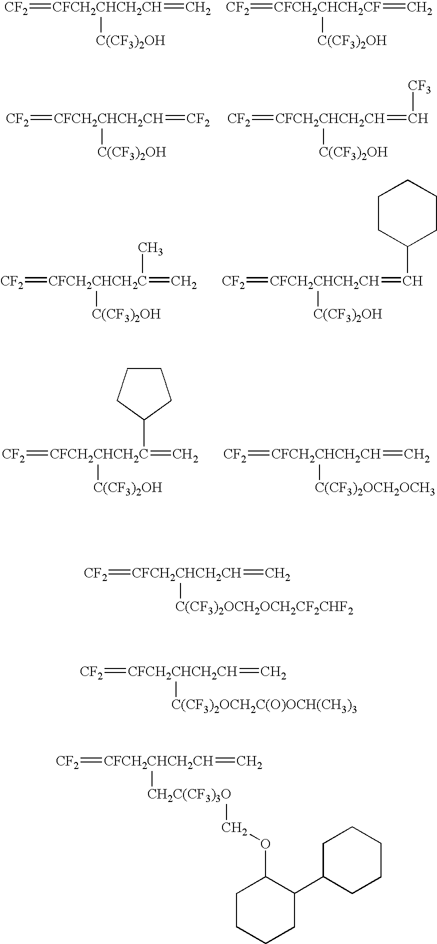

13. A resist composition comprising the fluorocopolymer (A) as defined in claim 1, an acid-generating compound which generates an acid under irradiation with light, and an organic solvent.

14. The fluorocopolymer (A) according to claim 3, wherein in the formula (1), R³ is at least one member selected from the group consisting of a hydrogen atom, a methyl group, a trifluoromethyl group, t-C₄H₉, CH₂OCH₃, CH₂OC₂H₅, CH₂OCH₂CF₃, CH₂OC₂H₄OCH₃, a 2-tetrahydropyranyl group, COOH, COO(t-C₄H₉), CH₂COOH, CH₂COO(t-C₄H₉), COO(2-methyladamant-2-yl), CH₂COO(2-methyladamant-2-yl) and the following groups (represented by the form of —OR³ in order to define the bonding position):

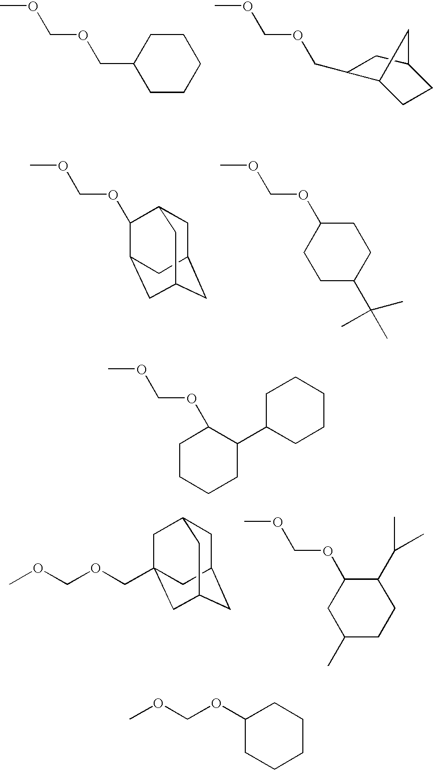

15. The fluorocopolymer (B) according to claim 4, wherein in the formula (1), R³ is at least one member selected from the group consisting of a hydrogen atom, a methyl group, a trifluoromethyl group, t-C₄H₉, CH₂OCH₃, CH₂OC₂H₅, CH₂OCH₂CF₃, CH₂OC₂H₄OCH₃, a 2-tetrahydropyranyl group, COOH, COO(t-C₄H₉), CH₂COOH, CH₂COO(t-C₄H₉), COO(2-methyladamant-2-yl), CH₂COO(2-methyladamant-2-yl) and the following groups (represented by the form of —OR³ in order to define the bonding position):

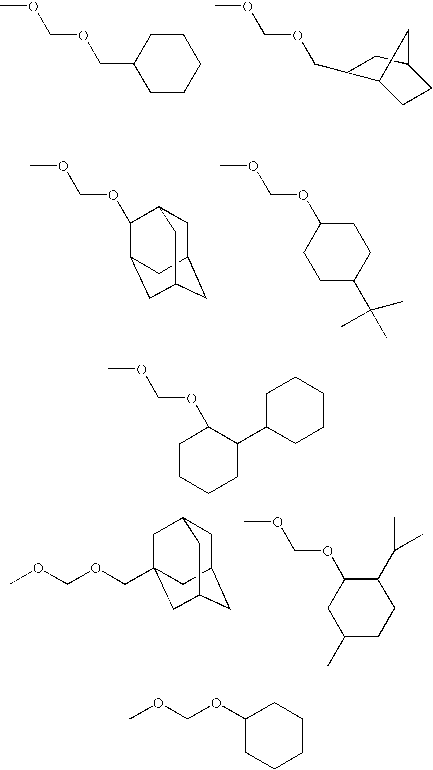

16. The fluorocopolymer (A) according to claim 3, wherein in the formula (2), each of R⁶ and R⁷ is a hydrogen atom, and the functional group in Q is a hydroxyl group, a methoxy group, a trifluoromethoxy group, CH₂OCH₃, OCH₂OCH₃, Ot-C₄H₉, CH₂OC₂H₅, OCH₂OC₂H₅, CH₂OCH₂CF₃, CH₂OC₂H₄OCH₃, a 2-tetrahydropyranyl group, COOH, COO(t-C₄H₉), CH₂COOH, OCH₂COOH, CH₂COO(t-C₄H₉), OCH₂COO(t-C₄H₉), COO(2-methyladamant-2-yl), CH₂COO(2-methyladamant-2-yl), OCH₂COO(2-methyladamant-2-yl) and the following groups (represented by the form of —OR³ in order to define the bonding position):

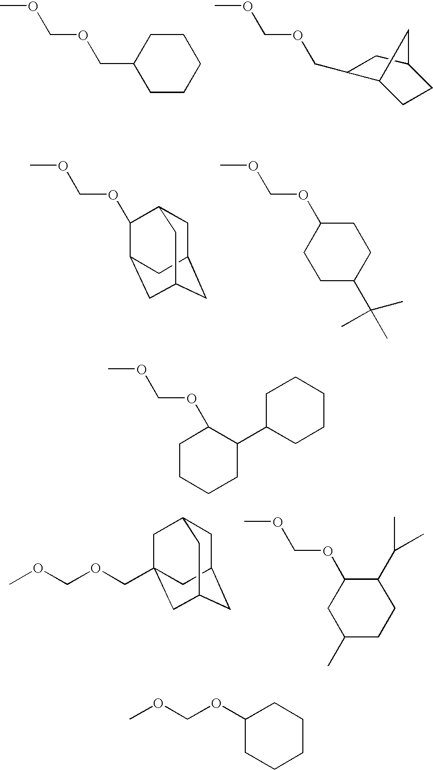

17. The fluorocopolymer (A) according to claim 5, wherein in the formula (2), each of R⁶ and R⁷ is a hydrogen atom, and the functional group in Q is a hydroxyl group, a methoxy group, a trifluoromethoxy group, CH₂OCH₃, OCH₂OCH₃, Ot-C₄H₉, CH₂OC₂H₅, OCH₂OC₂H₅, CH₂OCH₂CF₃, CH₂OC₂H₄OCH₃, a 2-tetrahydropyranyl group, COOH, COO(t-C₄H₉), CH₂COOH, OCH₂COOH, CH₂COO(t-C₄H₉), OCH₂COO(t-C₄H₉), COO(2-methyladamant-2-yl), CH₂COO(2-methyladamant-2-yl), OCH₂COO(2-methyladamant-2-yl) and the following groups (represented by the form of —OR³ in order to define the bonding position):

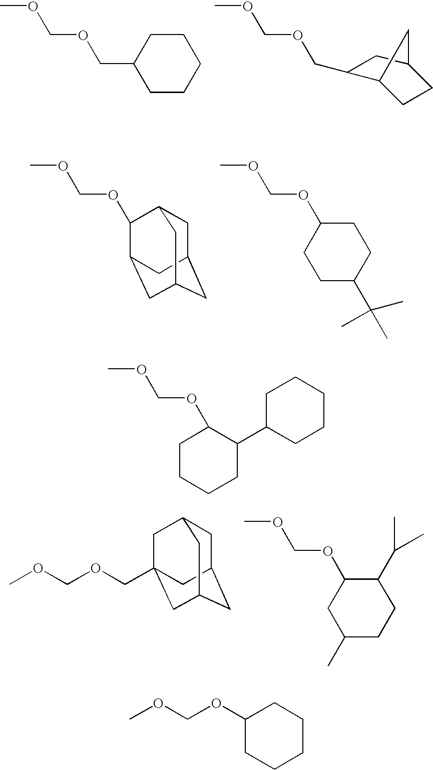

18. The fluorocopolymer (B) according to claim 4, wherein in the formula (3), R⁸ is a hydrogen atom, a fluorine atom, a methyl group or a trifluoromethyl group, and R⁹ is an alkyl group having at most 20 carbon atoms, provided that the alkyl group constituting R⁹ may have some or all of its hydrogen atoms substituted by fluorine atoms or hydroxyl groups, and the alkyl group constituting R⁹ may have some of its CH₂ groups substituted by oxygen atoms or carbonyl groups.

19. The fluorocopolymer (B) according to claim 6, wherein in the formula (3), R⁸ is a hydrogen atom, a fluorine atom, a methyl group or a trifluoromethyl group, and R⁹ is an alkyl group having at most 20 carbon atoms, provided that the alkyl group constituting R⁹ may have some or all of its hydrogen atoms substituted by fluorine atoms or hydroxyl groups, and the alkyl group constituting R⁹ may have some of its CH₂ groups substituted by oxygen atoms or carbonyl groups.

20. A resist composition comprising the fluorocopolymer (A) as defined in claim 3, an acid-generating compound which generates an acid under irradiation with light, and an organic solvent.

21. A resist composition comprising the fluorocopolymer (A) as defined in claim 5, an acid-generating compound which generates an acid under irradiation with light, and an organic solvent.

22. A resist composition comprising the fluorocopolymer (A) as defined in claim 7, an acid-generating compound which generates an acid under irradiation with light, and an organic solvent.

23. A resist composition comprising the fluorocopolymer (A) as defined in claim 11, an acid-generating compound which generates an acid under irradiation with light, and an organic solvent.

24. A resist composition comprising the fluorocopolymer (B) as defined in claim 2, an acid-generating compound which generates an acid under irradiation with light, and an organic solvent.

25. A resist composition comprising the fluorocopolymer (B) as defined in claim 4, an acid-generating compound which generates an acid under irradiation with light, and an organic solvent.

26. A resist composition comprising the fluorocopolymer (B) as defined in claim 6, an acid-generating compound which generates an acid under irradiation with light, and an organic solvent.

27. A resist composition comprising the fluorocopolymer (B) as defined in claim 8, an acid-generating compound which generates an acid under irradiation with light, and an organic solvent.

28. A resist composition comprising the fluorocopolymer (B) as defined in claim 12, an acid-generating compound which generates an acid under irradiation with light, and an organic solvent.
